(19) United States
(12) Patent Application Publication
(10) Pub. No.: US 2025/0319633 A1
(43) Pub. Date: Oct. 16, 2025

(54) A METHOD AND SYSTEM FOR RECYCLING AT LEAST A PORTION OF A TEXTILE MATERIAL COMPRISING POLYESTER FIBERS

(71) Applicant: Inter IKEA Systems B.V., Delft (NL)

(72) Inventors: Marius LEHADUS, Älmhult (SE); Karin LINDQVIST, Göteborg (SE); Erika TÖNNERFORS, Södertälje (SE)

(73) Assignee: Inter IKEA Systems B.V., Delft (NL)

(21) Appl. No.: 18/993,894

(22) PCT Filed: Jul. 13, 2023
(86) PCT No.: PCT/EP2023/069454

§ 371 Date: Jan. 13, 2025

(30) Foreign Application Priority Data
Jul. 15, 2022 (SE) 2250912-9

(51) Int. Cl. B29B 17/02; D01G 11/04

(52) U.S. Cl. CPC B29B 17/02; D01G 11/04; B29B 2017/0293

(57) ABSTRACT

The present invention describes a method of recycling at least a portion of a textile material comprising polyester fibers, the method comprising
a mixing step comprising bringing the textile material comprising polyester fibers and at least one other type of fibers into contact with a suspension comprising a catalyst and methanol in a rotatable drum of a reactor unit, the rotatable drum being arranged for rotating around an axis, said axis having an angle to the horizontal plane being less than 45°, preferable said rotatable drum being perforated;
a depolymerization step comprising providing a temperature of at least 80° C. in the reactor unit and rotating the drum to make the textile material tumble around inside thereof in contact with the catalyst and methanol to perform a methanolysis depolymerization reaction of the polyester portion of the textile material, leaving said other type of fibers in a fiber state; and
withdrawing from the reactor unit a liquid solution comprising depolymerized polyester, and withdrawing from the rotatable drum a fiber material comprising said other type of fibers.

### FIELD OF THE INVENTION

The present invention relates to a method and a system for recycling at least a portion of a textile material comprising polyester fibers.

### TECHNICAL BACKGROUND

There are known methods for recycling of polyester from polyester textiles. One such is disclosed in WO 2018/150028. WO 2018/150028 describes a polyester textile waste recycling method. In this method the polyester textile is soaked in a mixture comprising a solvent and a catalyst comprising calcium oxide, and heating the mixture to a temperature in a range of 80-240° C. and maintaining the temperature within this range during depolymerization of the polyester in the polyester textile.

The aim of the invention is to provide a method and system improving inter alia the depolymerization of polyester in a textile recycling system.

### SUMMARY OF THE INVENTION

The present invention provides a new method for recycling of a textile material comprising polyester fibers, where a novel reactor unit is involved for the depolymerization of the polyester in the textile material. Moreover, the present invention also provides a textile recycling system comprising such a reactor unit.

The stated purpose above is achieved by a method of recycling at least a portion of a textile material comprising polyester fibers, the method comprising
a mixing step comprising bringing the textile material comprising polyester fibers and at least one other type of fibers into contact with a suspension comprising a catalyst and methanol in a rotatable drum of a reactor unit, the rotatable drum being arranged for rotating around an axis, said axis having an angle to the horizontal plane being less than 45°;
a depolymerization step comprising providing a temperature of at least 80° C. in the reactor unit exposing the textile material to the catalyst and methanol to perform a methanolysis depolymerization reaction of the polyester portion of the textile material, leaving said other type of fibers in a fiber state;
wherein the drum is rotated during at least one of said mixing step and said depolymerization step to make the textile material tumble around inside thereof in contact with the catalyst and methanol;
   and
withdrawing from the reactor unit a liquid solution comprising depolymerized polyester, and withdrawing from the rotatable drum a fiber material comprising said other type of fibers.

The method according to the present invention is directed to a tumbling procedure where it is ensured that the textile material comprising polyester fibers and another fiber type is brought into contact with a suspension comprising a catalyst and methanol by being rotated in the rotatable drum of the reactor unit. This rotating procedure is advantageous when mixing the different components and is as such employed during the mixing step and/or the depolymerization step. This is also why the method involves rotation of the drum during at least one of said mixing step and said depolymerization step, and the rotation is preferably employed during at least a portion of both steps. This method provides an efficient manner of separating polyester, which is depolymerized under the action of the catalyst and methanol to form a solution of depolymerized polyester, from other fibers, such as cellulose fibers, e.g. cotton fibers, that are kept in a fiber state, i.e. in a solid state. Furthermore, rotation of the drum is also preferred during one or more subsequent suggested rinsing steps, which is further discussed below.

Moreover, as the rotation should be performed for the fibers being brought into contact with the suspension a regular rotation around a more or less horizontal axis is preferred. Also, a rotation with a somewhat tilted plane and angle is possible according to the present invention. Therefore, according to the present invention, the rotatable drum is arranged for rotating around an axis having an angle to the horizontal plane being less than 45°. It should however be noted that an angle to the horizontal plane below 25°, such as below 10° or even close to or being 0° is preferred according to the present invention.

It should be noted that the rotatable drum inside of a housing of the pressure vessel preferably is a perforated drum. This is preferable as it simplifies the separation of the methanol-monomer solution and the textile remaining in the rotatable drum after reaction, draining and spin drying.

According to one embodiment of the invention, the temperature in the reactor unit may be provided, during at least a portion of the depolymerization step, at a temperature of at least 100° C., preferably at least 110° C., more preferably at least 120° C. and most preferably at least 140° C. At such temperatures the process becomes increasingly efficient.

According to one embodiment of the invention, the temperature in the reactor unit may be provided, during at least a portion of the depolymerization step, at a temperature of 200° C. or less, preferably 180° C. or less, and most preferably 170° C. or less. At such temperatures the unwanted break-down of said other type of fibers is reduced.

According to one embodiment of the invention, the temperature in the reactor unit may be provided, during at least a portion of the depolymerization step, in a range of 100-200° C., preferably in a range of 110-180° C., more preferably in a range of 120-170° C., most preferably in a range of 140-170° C. A temperature below 200° C. is preferred to perform depolymerization of polyester in the presence of some fiber materials, e.g. cotton, that are sensitive to high temperatures. Moreover, methanol performs most optimal at lower temperatures than 200° C. Moreover, at temperatures below 100° C. the yield of depolymerized polyester is too low.

According to one embodiment of the present invention, the pressure in the reactor unit may be held, during at least a portion of the depolymerization step, at at least 5 bar, preferably at least 10 bar absolute pressure. The pressure depends on the temperature and the vapor pressure of the solvent at that specific temperature. Based on the solvent used and a set temperature, the pressure is obtained from the pressure-temperature dependency of that solvent.

According to an embodiment of the present invention, said at least one other fiber type of the textile material may comprise a cellulose based fiber, preferably at least one of natural cellulose fibers such as cotton, and linen, and man-made cellulose fibers, such as viscose, lyocell, rayon, and modal, more preferably said at least one other fiber type comprises at least cotton.

According to yet another embodiment of the present invention, said textile material may comprise at least 20 wt. %, or at least 30 wt. %, preferably at least 40 wt. %, more preferably at least 50 wt. %, cellulose based fibers, preferably said textile material comprises at least 20 wt. %, or at least 30 wt. %, preferably at least 40 wt. %, more preferably at least 50 wt. %, cotton fibers, still more preferably the textile material comprises at least 20 wt. %, or at least 30 wt. %, more preferably at least 40 wt. %, still more preferably at least 60 wt. %, of polycotton textile material.

According to one embodiment of the present invention, the catalyst may comprise Ca, preferably the catalyst comprises at least one of CaO, CaO-MgO and Ca(OH)₂. According to yet another embodiment of the present invention, the specific surface area of the catalyst may be at least 5 m²/g, preferably at least 10 m²/g, more preferably at least 15 m²/g, most preferably at least 20 m²/g. According to a further embodiment of the present invention, the catalyst is added at a concentration of 0.05-0.5 m² per gram of textile, preferably at a concentration of 0.08-0.4 m² per gram of textile.

According to one embodiment of the present invention, the methanolysis depolymerization reaction may be performed in an inert atmosphere in the reactor unit, preferably in a N₂ environment. The inert environment may prevent unwanted reactions.

According to yet another embodiment of the present invention, the method may comprise at least one subsequent rinsing step, for rinsing the fiber material remaining after the depolymerization of polyester. Preferably the subsequent rinsing step is performed in methanol being charged to the reactor unit. Preferably the rotatable drum is being rotated during at least a portion of the rinsing step. According to yet another embodiment of the present invention, the method may comprise multiple rinsing steps. According to yet another embodiment of the invention, said at least one rinsing step comprises a spin-drying rotation principle for separating methanol and depolymerized polyester from the fiber material. Even further, said at least one and first rinsing step and any additional further rinsing step may involve or may be preceded by draining before methanol may be added to the reactor unit for said rinsing step. Preferably the method may comprise draining and several rinsing steps where methanol is added to the reactor unit. Even more preferably draining may be performed in a temperature range of 120-160° C. and rinsing in a temperature range of 60-200° C.

According to an embodiment of the invention, the fiber material remaining in the rotatable drum after depolymerization of the polyester may be dried by applying a vacuum to the reactor unit. Also during the drying procedure it is preferable to keep the rotatable drum in rotation. Moreover, it is preferable to evaporate and remove methanol before withdrawing any fiber material from the drum.

According to an embodiment of the present invention, the catalyst and methanol solution may be discharged through an outlet with a particle filter after the depolymerization step, draining and/or rinsing step. This may be performed to filter off catalyst particles. This may preferably be performed for further use of the catalyst particles.

According to an embodiment of the present invention, the depolymerized polyester (dimethyl terephthalate, DMT) being produced may be concentrated, cooled and crystallized after the rinsing step. This may enable separation of the DMT and recirculation and reuse of the methanol to the reactor unit. Preferably the DMT may be cooled and crystallized in a separate crystallization reactor unit.

According to an embodiment of the present invention, the methanol may be recovered via at least one evaporation step or via distillation.

According to a second aspect of the invention, the present invention is a textile recycling system for recycling at least a portion of a textile material comprising polyester fibers, the system being arranged for conducting a methanolysis depolymerization reaction of polyester fibers and leaving a further type of fibers comprised in the textile material in a fiber state, the recycling system comprising a depolymerization reactor unit comprising a rotatable drum, the rotatable drum being arranged for rotating around an axis, said axis having an angle to the horizontal plane being less than 45°, and
said depolymerization reactor unit being a pressure vessel adapted to withstand a temperature of at least 80° C., preferably adapted to withstand a pressure of at least 5 bar, more preferably at least 10 bar absolute pressure.

According to an embodiment of the present invention, the angle to the horizontal plane of the shaft during rotation of the rotatable drum may be less than 25°. Preferably the angle to the horizontal plane may be in a range of from 0-10°.

According to yet another embodiment of the present invention, the rotatable drum may be perforated. The perforation is preferred to enable separation of methanol-monomer solution from the remaining textile after depolymerization reaction and/or after any potential subsequent steps, such as rinsing.

According to an embodiment of the present invention, the rotatable drum may be arranged inside a housing of the reactor unit. The housing may be arranged to maintain a desired pressure in the reactor unit and to collect solutions discharged via perforations of the perforated rotatable drum. In a preferred embodiment, the rotatable drum may be provided with perforations in its mantle portion and/or at least one of its gable portions. Further, in a more preferable embodiment, the rotatable drum may be provided with perforations in its mantle portion and at least one of its gable portions. Still in a more preferable embodiment, the rotatable drum may comprise perforations in its mantle portions and both its gable portions.

According to one embodiment of the present invention, the textile recycling system may also comprise separate charging means. The separate charging means may be for charging the reactor unit.

According to an embodiment of the present invention, the depolymerization reactor unit may comprise heating means. According to a preferred embodiment, such heating means may be arranged at the inside of the housing of the reactor unit. In a still more preferred embodiment, said heating means may be arranged at least partly in a space between the housing of the reactor unit and a mantle of the rotatable drum. Furthermore, heating of the reactor may be performed by using different types of fluids in a mantle, such as oil.

According to yet another embodiment of the present invention, the depolymerization reactor unit may be connected to an outlet with a particle filter.

According to one embodiment of the present invention, the textile recycling system may also comprise a crystallization reactor unit. The crystallization unit may be connected to the depolymerization reactor unit. In a preferred embodiment, the crystallization unit may further comprise a recirculation loop. The recirculation loop may be for recirculation of a solvent from the crystallization reactor unit to the depolymerization reactor unit. In a preferred embodiment, the recirculation loop may go via at least an evaporator unit or via a distillation unit or a combination thereof.

According to an embodiment of the present invention, the system may be arranged for rotating the rotatable drum in a spin drying mode. This may be done for separating solutions comprising methanol and depolymerized polyester from the fiber material subsequent to a depolymerization step, and/or for separating methanol from the fiber material in a rinsing step. According to yet another embodiment of the present invention, the rotatable drum may be arranged for maintaining the fiber material inside the rotatable drum during such spin drying and for allowing solutions to be released from the drum via perforations and be collected in a housing of the reactor unit and subsequently withdrawn via a discharge outlet.

According to an embodiment of the present invention, the system may comprise a vacuum arrangement. The vacuum arrangement may be used for applying a vacuum to the reactor unit for drying a fiber material retained in the rotatable drum by evaporation of methanol.

### BRIEF DESCRIPTION OF THE DRAWINGS

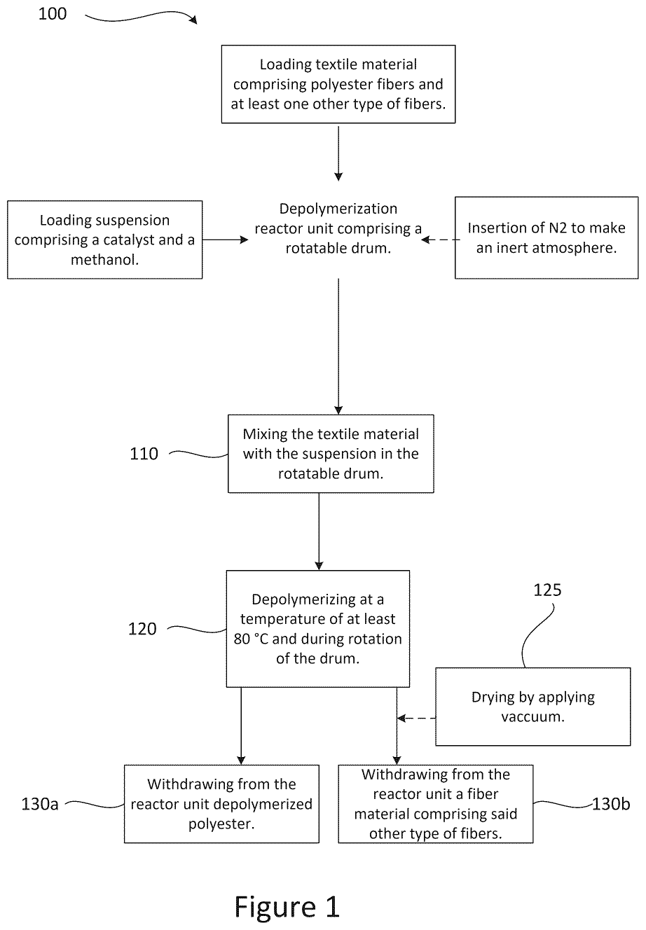

In FIG. 1 there is shown a schematic view of the steps involved in at least one embodiment of the method according to the present invention.

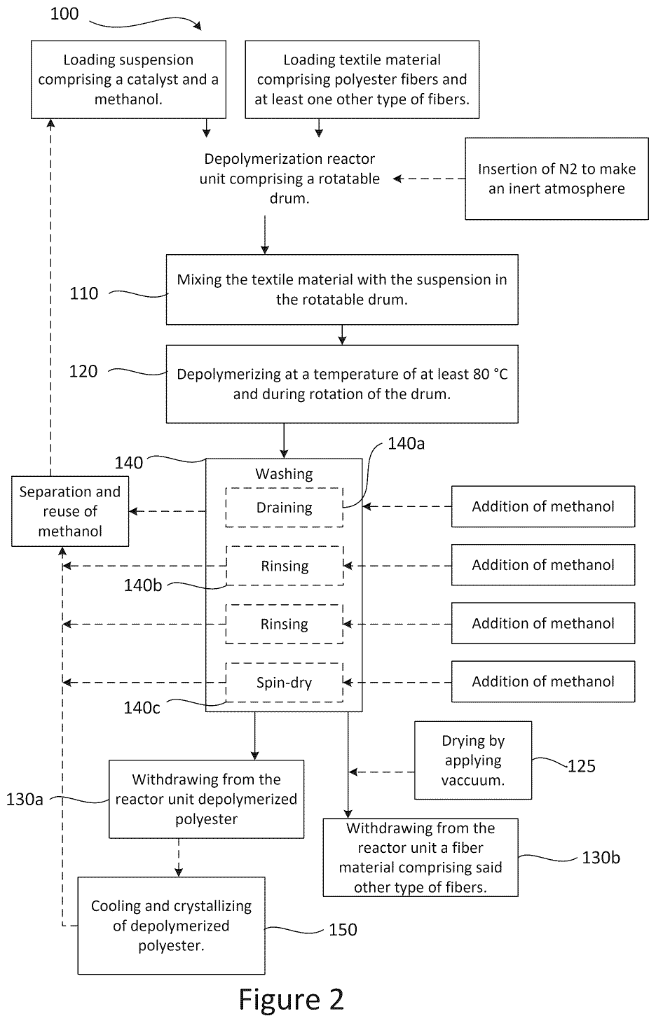

In FIG. 2 there is shown a schematic view of the steps involved in at least one embodiment of the method according to the present invention.

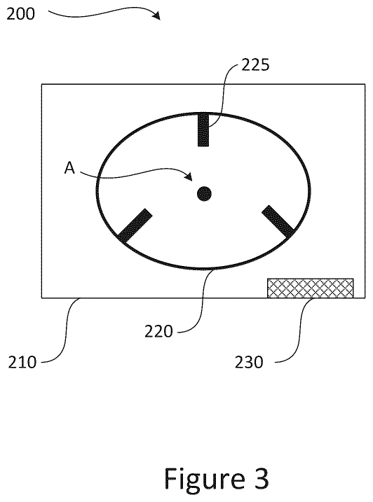

In FIG. 3 there is shown a schematic view of one embodiment of a textile recycling system according to the present invention.

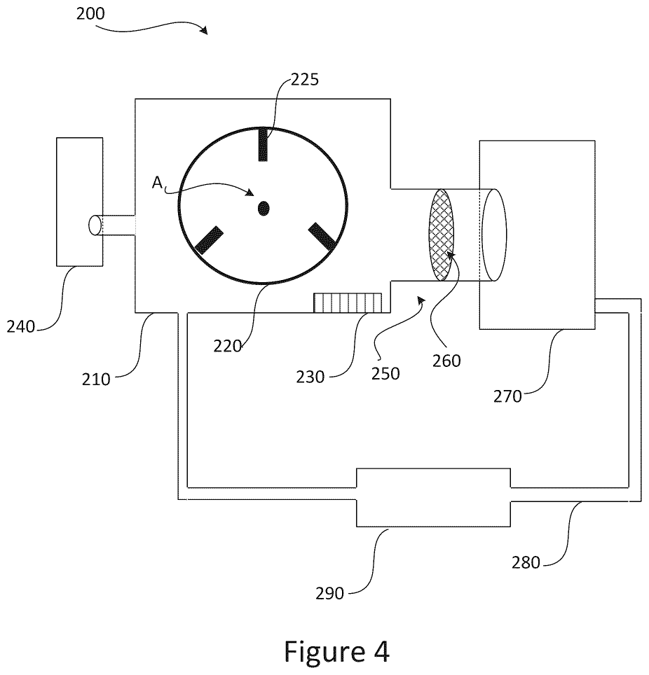

In FIG. 4 there is shown a schematic view of a further embodiment of a textile recycling system according to the present invention.

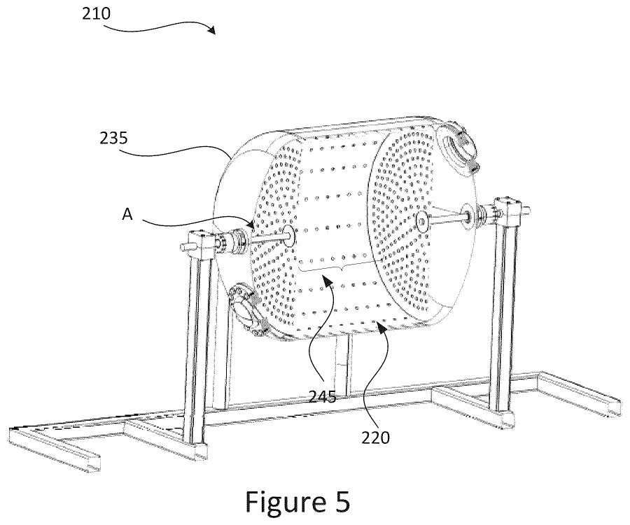

In FIG. 5 there is shown a schematic cross sectional view of one embodiment of a recycling system according to the present invention.

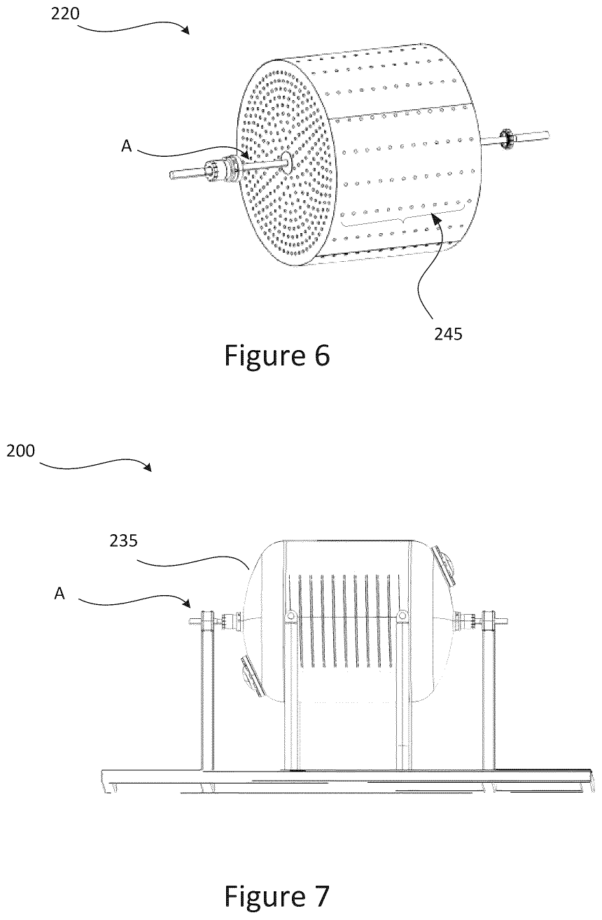

In FIG. 6 there is shown a schematic view of one embodiment of a recycling system according to the present invention.

In FIG. 7 there is shown a schematic side view of one embodiment of a recycling system according to the present invention.

### EMBODIMENTS OF THE INVENTION

Below specific embodiments of the present invention are disclosed and further explained.

According to one embodiment, the temperature in the reactor unit is provided, during at least a portion of the depolymerization step, in a range of 100-200° C., preferably in a range of 110-180° C., more preferably in a range of 120-170° C., most preferably in a range of 140-170° C. Above 200° C. it is not preferred to perform depolymerization of some fiber materials, e.g. cotton. Moreover, also the methanol is affected negatively at high temperatures. Moreover, at temperatures below 100° C. the yield of depolymerized polyester is too low. Taking these aspects into account, a temperature range of 140-170° C. is preferred.

The pressure is also a relevant feature. According to yet another embodiment, the pressure in the reactor unit is held, during at least a portion of the depolymerization step, at at least 5 bar, preferably at least 10 bar absolute pressure.

Pressures up to and above 20 bar are also totally possible. Preferably the pressure is less than 40 bar, such as less than 30 bar. Preferably, the pressure in the reactor is held, during at least a portion of the depolymerization reaction, in the range of 10-25 bar absolute pressure.

Moreover, according to one preferred embodiment, the rotatable drum is provided with perforations, preferably perforations at least on a mantle surface.

Moreover, controlling the reactor environment for more than temperature and pressure may also be of relevance. For instance, to set the right gas environment in the reactor unit is also of interest. As an example, according to one embodiment of the present invention, the methanolysis depolymerization reaction is performed in an inert atmosphere in the reactor unit, preferably in a N₂ environment. This prevents unwanted reactions.

In addition to polyester fiber, different fiber types may be used in a fiber blend according to the present invention. In line with this, according to one embodiment of the present invention, said at least one other fiber type of the textile material comprises a cellulose based fiber, preferably at least one of natural cellulose fibers such as cotton, and linen, and man-made cellulose fibers, such as viscose, lyocell, rayon, and modal, more preferably said at least one other fiber type comprises at least cotton.

Moreover, according to yet another embodiment, said textile material comprises at least 30 wt. %, preferably at least 40 wt. %, more preferably at least 50 wt. %, cellulose based fibers, preferably said textile material comprises at least 30 wt. %, preferably at least 40 wt. %, more preferably at least 50 wt. %, cotton fibers, still more preferably the textile material comprises at least 30 wt %, preferably at least 40 wt %, more preferably at least 60 wt. %, of polycotton textile material. As should be understood from above, polycotton is a preferred fiber blend to use according to the present invention.

Different catalysts may be used according to the present invention. According to yet another embodiment of the present invention, the catalyst comprises Ca, preferably the catalyst comprises at least one of CaO, CaO-MgO and Ca(OH)₂.

The calcium access is a key property of the catalyst to be used according to the present invention. Furthermore, also other parameters are of relevance. One such parameter is specific surface area. A high specific surface area may be obtained by providing comparatively small catalyst particles. As an example, grinding may be used to ensure an intended maximum size. Total catalyst surface area is usually measured by using the BET (Brunauer-Emmett-Teller) method. According to one embodiment of the present invention, the totalt surface area of the catalyst is at least 5 m²/g, preferably at least 10 m²/g, more preferably at least 15 m²/g, most preferably at least 20 m²/g. According to a further embodiment of the present invention, the catalyst is added at a concentration of 0.05-0.5 m²/g of textile, preferably at a concentration of 0.08-0.4 m²/g of textile. Examples are 0.05 m² of catalyst per gram of textile, or 0.15 m² of catalyst per gram of textile, or 0.3 m² of catalyst per gram of textile.

Furthermore, according to one embodiment of the present invention, the catalyst and methanol solution is fed through an outlet with a particle filter after the depolymerization step or rinsing step to filter off catalyst particles, preferably for further use. The catalyst used may be filtered off and then follow a waste stream, reusage is another possibility. According to this embodiment, residues and used catalyst or unused catalyst particles are filtered off. DMT (depolymerized polyester), however are passed through the filter for the next step in the process. Furthermore, residues of catalysts are washed away from the treated textile material later on in the process.

In line with the above, according to yet another embodiment of the invention, the method comprises at least one subsequent rinsing step, preferably performed in methanol being charged to the reactor unit, preferably the rotatable drum being rotated during at least a portion of the rinsing step, more preferably the method comprises multiple rinsing steps.

Furthermore, preferably said at least one rinsing step comprises a spin-drying rotation principle for separating methanol and depolymerized polyester from the fiber material. Also here rotation is involved in the method according to the present invention.

According to yet another embodiment of the invention, said at least one rinsing step and any additional rinsing step involves or is preceded by draining before methanol is added to the reactor unit, preferably the method comprises draining and several rinsing steps where methanol is added to the reactor unit, more preferably where draining is performed in a temperature range of 120-160° C. and rinsing in a temperature range of 60-200° C.

According to yet another embodiment of the present invention, the depolymerized polyester (dimethyl terephthalate, DMT) being produced is concentrated, cooled and crystallized after the rinsing step to enable separation of the DMT and recirculation and reuse of the methanol to the reactor unit, preferably the DMT is cooled and crystallized in a separate crystallization reactor unit.

Moreover, according to one embodiment of the present invention, methanol is recovered via at least one distillation or evaporation step. After the final spin drying, the reactor is coupled to vacuum to evaporate any remaining methanol from the remaining textile while rotating the textile. Since the reactor still is warm this means that the textile in the reactor is tumble dried.

The present invention also refers to a textile recycling system comprising a methanolysis depolymerization reactor unit. According to the present invention there is provided a textile recycling system for recycling at least a portion of a textile material comprising polyester fibers, the system being arranged for conducting a methanolysis depolymerization reaction of polyester fibers and leaving a further type of fibers comprised in the textile material in a fiber state, the recycling system comprising a depolymerization reactor unit comprising a rotatable drum, the rotatable drum being arranged for rotating around an axis, said axis having an angle to the horizontal plane being less than 45°, and
said depolymerization reactor unit being a pressure vessel adapted to withstand a temperature of at least 80° C., preferably adapted to withstand a pressure of at least 5 bar, more preferably at least 10 bar.

As mentioned above, the rotatable drum is preferably arranged to rotate around a more or less horizontal axis, but some difference thereto is possible. In line with this, according to one embodiment, the angle to the horizontal plane is less than 25°, preferably in a range of from 0-10°.

Preferably, the rotatable drum is perforated to enable separation of methanol-monomer solution from the remaining textile after depolymerization reaction and potential subsequent steps. The rotatable drum is arranged inside a housing of the reactor unit. The housing is arranged to maintain a desired pressure in the reactor unit and collect solutions discharged via perforations of the perforated rotatable drum. Preferably the rotatable drum is provided with perforations in its mantle portion and/or at least one of its gable portions, more preferably the rotatable drum is provided with perforations in its mantle portion and at least one of its gable portions, still more preferably the rotatable drum comprises perforations in its mantle portions and both its gable portions.

Preferably the depolymerization reactor unit comprises heating means. This makes it easier to hold a desired process temperature during the depolymerization reactions. Preferably such heating means is arranged at the inside of a housing of the reactor unit. Still more preferably said heating means is arranged at least partly in a space between the housing of the reactor unit and a mantle of the rotatable drum. The heating means of the system according to the present invention are adapted to heat to at least 80° C., preferably to at least 100° C., more preferably to at least 120° C., more preferably to at least 140° C., most preferably at least 170° C., or even up to at least 200° C.

Furthermore, also cooling means may be of relevance to incorporate. Such cooling means may be included in a mechanical gasket of the reactor unit.

Furthermore, the textile recycling system according to the present invention is preferably based on using vacuum as means for charging the reactor unit. The textile recycling system may also comprise separate charging means for charging the reactor unit. This reactor unit functions as a pressure vessel to enable it to perform an efficient depolymerization reaction. This type of system is also simple with reference to applying an inert environment, which is a benefit as mentioned above. The system according to the present invention may instead be based on incorporating a pump for charging, however this has the disadvantage of ensuring ATEX classification of certain equipment as methanol is considered a flammable solvent.

As mentioned above, rotation of the drum, preferably being perforated, of the reactor unit is an important aspect according to the present invention. First of all, rotation is of interest during the charging as this increases the even distribution of the catalyst particles over the textile material. Secondly, rotation is important during the rinsing step(s) after a conducted depolymerization reaction to separate the methanol and depolymerized polyester in solution from the fiber material inside the drum. Rotation may of course also be performed during at least one part of the depolymerization reaction. It should further be noted that the rotation direction may be one and the same or may be alternated at least once during the procedure of the present method. Distribution of catalyst over the entire textile material is of important and changing the rotation direction may be helpful to diminish the risk of entanglement of the textile material to be treated. To this end the drum may be provided with internal paddles to improve the mixing of the textile with catalyst and methanol.

Moreover, according to yet another embodiment, the textile recycling system also comprises separate charging means for charging the reactor unit. This may be of interest to simplify the charging by vacuum and ensuring an inert atmosphere in the reaction unit when needed. Suitably the charging means is a charging vessel.

Furthermore, according to one embodiment of the present invention, the depolymerization reactor unit is connected to an outlet with a particle filter. Here the catalyst particles still being present may be filtered off along with any solid textile fragments and other particles, such as particulate pigments.

According to yet another embodiment of the present invention, the textile recycling system also comprises a crystallization reactor unit being connected to the depolymerization reactor unit, preferably also comprising a recirculation loop for recirculation of a solvent from the crystallization reactor unit to the depolymerization reactor unit, preferably via at least a distillation unit or an evaporator unit or a combination thereof. As one example, a thin film evaporator may be included in the system according to the present invention. To recover and recycle methanol for reusing the same is of course of interest in a system according to the present invention.

### Detailed Description of the Drawings

Below follows a detailed description of the drawings.

FIG. 1 shows a schematic view of the steps involved in one embodiment of the method 100 according to the present invention. The method 100 comprises three steps, 110, 120, 130a and 130b.

The textile material comprising polyester fibers and at least one other type of fibers are loaded into a depolymerization reactor unit comprising a rotatable drum. Said at least one other fiber type of the textile material may comprise a cellulose based fiber. It may preferably be at least one of natural cellulose fibers such as cotton, and linen, and man-made cellulose fibers, such as viscose, lyocell, rayon, and modal, more preferably said at least one other fiber type comprises at least cotton. Moreover, the textile material may comprise at least 30 wt %, preferably at least 40 wt % cellulose based fibers. Such as at least 50 wt %, cellulose based fibers. Further, the textile material may comprise at least 30 wt %, preferably at least 40 wt % cotton fibers, such as at least 50 wt % cotton fibers. Even further, the textile material may comprise at least 60 wt % of polycotton textile material.

Following the textile material, the suspension comprising a catalyst and a methanol are loaded to the reactor unit. Alternatively, but sometimes less preferred, the catalyst may be added in solid form, and thereafter the methanol is added and mixed with the catalyst and the textile. The catalyst may comprise Ca, preferably the catalyst may comprise at least one of CaO, CaO-MgO, and Ca(OH)₂. In this regard it should be noted that CaMg(CO₃)₂, which for example is found in the mineral dolomite, may function as the raw material which during the preparation of the catalyst is calcined (heat treated) and turned into CaO-MgO, which oxides then act as the catalyst.

The first step 110 of the method 100 is a mixing step 110. In the first step 110 the textile material comprising polyester fibers and at least one other type of fibers is brought into contact with the suspension comprising a catalyst and methanol in a rotatable drum of a reactor unit. The rotatable drum being arranged for rotating around an axis, said axis having an angle to the horizontal plane being less than 45°. For example, the angle may be less than 25°, such as in the range of from 0-10°. The angle of the rotatable drum to the horizontal plane ensures proper mixing of the textile material and the suspension, during tumbling of the rotatable drum.

The second step 120 is a depolymerizing step 120, which comprises providing a temperature of at least 80° C. in the reactor unit and rotating the drum to make the textile material tumble around inside thereof. The temperature in the reactor unit, during at least a portion of the depolymerization step, may be in the range of 100-200° C. Preferably the temperature may be in the range of 110-180° C., such as in the range of 120-170° C., or in the range of 140-170° C. Moreover, the pressure in the reactor unit may be held, during at least a portion of the depolymerization step, at at least 5 bar, for example at at least 10 bar, such as up to or above 20 bar. The pressure will depend on the temperature. The tumbling during the depolymerizing step 120 makes the textile come into contact with the catalyst and methanol to perform a methanolysis depolymerization reaction of the polyester portion of the textile material, leaving said other type of fibers in a fiber state. The drum is rotated during at least one of said mixing step 110 and said depolymerization step 120.

The third step has two parallel sub-steps 130a and 130b. During the third step 130a and 130b the textile material is withdrawn in two portions. One portion 130a withdraws from the reactor unit the depolymerized polyester and the second portion 130b withdraws from the reactor unit a fiber material comprising said other type of fibers.

As may be seen in both FIGS. 1 and 2, the fiber material remaining in the rotatable drum 220 after depolymerization of the polyester may be dried by applying a vacuum 125 to the reactor unit 210 to evaporate methanol.

During the method, the atmosphere suitably is inert. For example, the methanolysis depolymerization reaction may be performed in an inert atmosphere in the reactor unit. To acquire the inert atmosphere, N₂ may be inserted to the reactor unit during any of the steps.

FIG. 2 shows a schematic view of the steps involved in one embodiment of the method 100 according to the present invention. The first two steps 110 and 120 are the same steps as in FIG. 1. Hence, focus on the description related to FIG. 2 will be on the additional third step 140 and fourth step 150.

The third step 140 is a rinsing step. The rinsing step 140 may comprise a draining step 140a. The draining step 140a drains the methanol and depolymerized polyester from the drum. There may be multiple rinsing steps 140 performed one after the other, such as up to three steps or more. The at least one rinsing step 140 is preferably performed in methanol being charged to the reactor unit. Preferably, the rotatable drum is being rotated during at least a portion of the at least one rinsing step 140. The rinsing step 140 may comprise sub-steps 140a, 140b and 140c. The at least one rinsing step 140 may comprise draining 140a, one or more rinsing steps 140b and a spin-drying 140c rotation principle step. The spin drying step 140c includes rotating the rotatable drum at such an rpm that a substantial amount of the methanol and depolymerized polyester leaves the remaining fiber material due to centrifugal action. Suitably, there is involved a spin drying step 140c after the draining 140a in order to more effectively remove methanol-monomer solution from the textile. The spin drying 140c is suitably be repeated after each rinsing step 140b in order to remove as much methanol as possible from the remaining textile.

During the draining 140a and rinsing 140b, methanol may be added to the reactor unit. Preferably the draining 140a is performed in a temperature range of 120-160° C. and the rinsing 140b is performed in a temperature range of 60-200° C.

The catalyst and methanol solution may be discharged through an outlet with a particle filter after the depolymerization step or one or more rinsing steps 140 to filter off catalyst particles. Preferably the catalyst and methanol may be reused in the method. The methanol may be recovered via at least one distillation or evaporation step.

The fourth step is cooling and crystallizing 150 of the depolymerized polyester (dimethyl terephthalate, DMT) coming from step 130a. This may be done to enable separation of the DMT and recirculation and reuse of the methanol to the reactor unit.

Preferably the DMT is cooled and crystallized 150 in a separate crystallization reactor unit.

In FIG. 3 there is shown a schematic view of one embodiment of a textile recycling system 200 according to the present invention. The system 200 is being arranged for conducting a methanolysis depolymerization reaction of polyester fibers when leaving a further type of fibers comprised in the textile material in a fiber state. The recycling system 200 comprises a depolymerization reactor unit 210. The reactor unit 210 comprises a rotatable drum 220. The rotatable drum 220 is arranged for rotating around an axis. The axis A has an angle to the horizontal plane being less than 45°, such as less than 25° or preferably in a range of from 0-10°. The axis A in FIG. 3 should be interpreted as going into the plane of the figure. In a preferred embodiment, the reactor unit 210 further comprises paddles 225. The paddles 225 may be used to improve the tumbling of the textile fabric. An improved tumbling may provide better mixing of the textile fabric and the suspension of catalyst and methanol. The reactor unit 210 may further comprises heating means 230. The heating means 230 may be used to set the reactor unit 210 at a temperature of at least 80° C. For example, it is set to a temperature in the range of 100-200° C., such in a range of 110-180° C., more preferably in the range of 120-170° C., most preferably in the range of 140-170° C. Moreover, also cooling means are preferably provided to enable cooling of the reactor unit. Heating and cooling may be enabled via a jacket of the reactor unit 210.

Moreover, as said the reactor unit 210 is a pressure vessel. In a preferred embodiment, the reactor unit is adapted to withstand a pressure of at least 5 bar, even more preferably at least 10 bar. It should be noted that the method and system according to the present invention may be performed at pressures in a range of 15-20 bars and even higher.

In FIG. 4 there is shown a schematic view of one embodiment of a textile recycling system 200 according to the present invention. There are several parts of FIG. 4 which equal those in FIG. 3. Hence, focus on the description related to FIG. 4 will be on the additional parts of the system 200.

The textile recycling system 200 may further comprise charging means 240 for charging the reactor unit 210. The charging means 240 may be used for charging the reactor unit 210 with nitrogen, catalyst and methanol throughout the use of the system. The rotatable drum 220 may be provided with lids (not shown) for charging to the drum the textile material that is to be treated according to the method, and for withdrawing from the drum the fiber material remaining after the depolymerization, and any rinsing.

Even further, the depolymerization reactor unit 210 may further comprise an outlet 250 with a particle filter 260. The particle filter 260 may be used to separate and filtrate particles from the depolymerization reactor unit, such as spent catalyst and particles still in the suspension.

The textile recycling system 200 may also comprise a crystallization reactor unit 270. The crystallization reactor unit 270 may be connected to the depolymerization reactor unit 210. Preferably, the textile recycling system also comprises a recirculation loop 280. The recirculation loop 280 may be used for recirculation of a solvent from the crystallization reactor unit 270 to the depolymerization reactor unit 210. Moreover, the textile recycling system may comprise at least a distillation unit or an evaporator unit 290 or a combination thereof. The recirculation loop 280 may recirculate the solvent via at least the distillation unit 290 or an evaporator unit 290 or a combination thereof.

In FIG. 5 there is shown a schematic cross sectional view of one embodiment of a reactor unit 210 that can be used in the system 200 and method according to the present invention. There are several parts of FIG. 5 which equal those in FIG. 3 and FIG. 4. Hence, focus on the description related to FIG. 5 will be on the reactor unit 210.

The rotatable drum 220 may further be arranged inside a housing 235 of the reactor unit 210. The housing 235 may be arranged to maintain a desired pressure in the reactor unit 210. Further, the housing 235 may be arranged to collect solutions discharged via perforations 245 of the perforated rotatable drum 220, The perforations will be further described in connection with FIG. 6.

In FIG. 6 there is shown a schematic view of one embodiment of a rotatable rum 220 according to the present invention.

Preferably the rotatable drum 220 is perforated with perforations 245. The perforations 245 enables separation of methanol-monomer solution from the remaining textile after depolymerization reaction and potential subsequent steps, i.e. draining and spin drying.

The perforations 245 of the rotatable drum 220 may be located in the mantle portion 246 of the rotatable drum 220. Further, the perforations 245 may be located on at least one of its gable portions 247. More preferably the rotatable drum is provided with perforations 245 in its mantle portion 246 and at least one of its gable portions 247.

Still more preferably the rotatable drum 220 comprising perforations 245 in its mantle portions 246 and both its gable portions 247.

In FIG. 7 there is shown a schematic side view of one embodiment of the reactor unit 210. The reactor unit 210 comprises the pressure vessel 235. Heating means 230 are as an example arranged in the space between the pressure vessel 235 and the rotatable drum 220. Such as at least partly in a space between the housing 235 and a mantle 246 of the rotatable drum 220.

A shaft, coinciding with the axis A, extends into the reactor unit 210 to enable rotation of the drum 220. A motor, not shown in FIG. 7, is connected to the shaft for the purpose of rotating the drum 220.

1. A method of recycling at least a portion of a textile material comprising polyester fibers, the method comprising
a mixing step comprising bringing the textile material comprising polyester fibers and at least one other type of fibers into contact with a suspension comprising a catalyst and methanol in a rotatable drum of a reactor unit, the rotatable drum being arranged for rotating around an axis (A), said axis (A) having an angle to the horizontal plane being less than 45°;
a depolymerization step comprising providing a temperature of at least 80° C. in the reactor unit exposing the textile to the catalyst and methanol to perform a methanolysis depolymerization reaction of the polyester portion of the textile material, leaving said other type of fibers in a fiber state;
wherein the drum is rotated during at least one of said mixing step and said depolymerization step to make the textile material tumble around inside thereof in contact with the catalyst and methanol,
and
withdrawing from the reactor unit a liquid solution comprising depolymerized polyester, and withdrawing from the reactor unit a fiber material comprising said other type of fibers.

2. The method according to claim 1, wherein the temperature in the reactor unit is provided, during at least a portion of the depolymerization step, in a range of 100 to 200° C., 110 to 180° C., 120-170° C., or 140 to 170° C.; and/or wherein the pressure in the reactor is held, during at least a portion of the depolymerization step, at at least 5 bar, or at least 10 bar absolute pressure, the pressure being less than 40 bar absolute pressure, or less than 30 bar absolute pressue.

3. (canceled)

4. The method according to claim 1, wherein said at least one other fiber type of the textile material comprises a cellulose based fiber.

5. The method according to claim 4, wherein said textile material comprises at least 30 wt. %, at least 40 wt. %, or at least 50 wt. %, cellulose based fibers.

6. The method according to claim 1, wherein the catalyst comprises at least one of CaO, CaO-MgO and Ca(OH)₂.

7. The method according to claim 1, wherein the specific surface area of the catalyst is at least 5 m²/g, preferably at least 10 m²/g, at least 15 m²/g, at least 20 m²/g; and/or wherein the catalyst is added at a concentration of 0.05 to 0.5 m² per gram of textile, or at a concentration of 0.08 to 0.4 m² per gram

8. (canceled)

9. The method according to claim 1, wherein the methanolysis depolymerization reaction is performed in an inert atmosphere in the reactor unit.

10. The method according to claim , wherein the method comprises at least one subsequent rinsing step for rinsing the fiber material remaining after the depolymerization of polyester, the rinsing step being being performed in methanol being charged to the reactor unit.

11. The method according to claim 10, wherein said at least one rinsing step comprises a spin-drying rotation principle for separating methanol and depolymerized polyester from the fiber material.

12. The method according to claim 10, wherein said at least one and first rinsing step involves or is preceded by draining before methanol is added to the reactor unit; and/or wherein the fiber material remaining in the rotatable drum after depolymerization of the polyester is dried by applying a vacuum to the reactor unit to evaporate methanol.

13. (canceled)

14. method according to claim 1, wherein the catalyst and methanol solution is discharged through an outlet with a particle filter after the depolymerization step or rinsing step to filter off catalyst particles.

15. The method according to claim 1, wherein depolymerized polyester (DMT) being produced is concentrated, cooled and crystallized after said step of withdrawing from the reactor unit a liquid solution comprising depolymerized polyester, and optionally after any rinsing step, to enable separation of the DMT and recirculation and reuse of the methanol to the reactor unit.

16. The method according to claim 15, wherein methanol is recovered via at least one evaporation step or via distillation.

17. A textile recycling system for recycling at least a portion of a textile material comprising polyester fibers, the system being arranged for conducting a methanolysis depolymerization reaction of polyester fibers and leaving a further type of fibers comprised in the textile material in a fiber state, the recycling system comprising a depolymerization reactor unit comprising a rotatable drum, the rotatable drum being arranged for rotating around an axis, said axis having an angle to the horizontal plane being less than 45°, and
said depolymerization reactor unit being a pressure vessel adapted to withstand a temperature of at least 80° C., and a pressure of at least 5 bar, or at least 10 bar.

18. The textile recycling system according to claim 17, wherein the angle to the horizontal plane of the shaft during rotation of the rotatable drum is less than 25°.

19. The textile recycling system according to claim 17, wherein the rotatable drum is perforated to enable separation of methanol-monomer solution and remaining textile after depolymerization reaction and potential subsequent steps, the rotatable drum being arranged inside a housingof the reactor unit, the housing being arranged to maintain a desired pressure in the reactor unit and collect solutions discharged via perforations of the perforated rotatable drum.

20. The textile recycling system according to claim 17, wherein the textile recycling system also comprises separate charging means for charging the reactor unit, and/or wherein said depolymerization reactor unit comprises heating means; and/or wherein yhe textile recycling system also comprises a crystallization reactor unit being connected to the deploymerization reactor unit.

21. The textile recycling system according to claim 17, wherein the depolymerization reactor unit is connected to an outlet with a particle filter.

22. (canceled)

23. The textile recycling system according to claim 17, wherein the textile recycling system is arranged for rotating the rotatable drum in a spin drying mode for separating solutions comprising methanol and depolymerized polyester from the fiber material subsequent to a depolymerization step, and/or for separating methanol from the fiber material in a rinsing step, the rotatable drum being arranged for maintaining the fiber material inside the rotatable drum during such spin drying and for allowing solutions to be released from the drum via perforations and be collected in a housing of the reactor unit and subsequently withdrawn via a discharge outlet; and/or wherein the textile recycling system comprises a vacuum arrangement for applying a vacuum to the reactor unit for drying a fiber material retained in the rotatable drum by evaporation of methanol.

24. (canceled)
